(19) United States
(12) Patent Application Publication
(10) Pub. No.: US 2011/0295834 A1
(43) Pub. Date: Dec. 1, 2011

(54) METHOD FOR OPTIMIZING A SEARCH QUERY

(76) Inventors: Stefan Augustin, Munchen (DE); Martin Kessner, Munchen (DE); Philipp Quaet-Faslem, Munchen (DE)

(21) Appl. No.: 13/117,772

(22) Filed: May 27, 2011

(30) Foreign Application Priority Data
May 31, 2010 (DE) 10 2010 022 263.1

(51) Int. Cl. G06F 17/30

(52) U.S. Cl. 707/713; 707/E17.131

(57) ABSTRACT

A user is provided with an analytical function which indicates an individual contribution of each search term used in a complex search query by a graphical, typographical or numerical indicator. For this purpose there is started in the background for each search term a search query which consists of the complex search query without the respective search term. The hit count obtained in this way is subtracted from the total hit count of the search query with the respective search term. The difference is a numerical indicator for the individual contribution of the respective search term to the total hit count. Thus, the user quickly and conveniently obtains a reference point indicating which search terms are crucial to the search query. The user can thus selectively refine the search query by explicitly specifying less significant search terms or removing overly restrictive search terms.

### CROSS-REFERENCE TO RELATED APPLICATIONS

This application claims priority to German Patent Application No. 10 2010 022 263.1 filed May 31, 2011. The contents of which are incorporated herein by reference in its entirety

### TECHNICAL FIELD

The present application concerns a method for optimizing a search query

### BACKGROUND

A typical way of accessing large databases is to enter search queries into a search mask. Repeated optimizing and refining of the search queries by a user is necessary in order to achieve a desired search result.

### SUMMARY

According to various embodiments, a method for optimizing a search query which supports a user in the formulation of the search query can be provided.

According to an embodiment, in a method for optimizing a search query, a microprocessor is programmed to—record in a first step with the aid of a search mask a search query which consists at least of a first search term and a second search term, the two search terms being linked by means of a first operator, and—perform the following steps iteratively while the search mask is continuously displayed by a visual output means: —record changes to the previous search query in the search mask in a second step, in particular as a result of modifying, removing or adding search terms, thereby forming a new search query, —interrogate a database with the new search query in order to determine a hit count in a third step, —for each search term of the new search query, —form a modified search query in a fourth step by removing the respective search term from the new search query, —interrogate the database with the respective modified search query in order to determine a modified hit count in a fifth step, —calculate a difference between the modified hit count and the hit count of the new search query in a sixth step, and—determine an indicator for the respective search term on the basis of the calculated difference and output the indicator in a seventh step.

According to a further embodiment, the indicators can be graphical representations, in particular bars, colored areas or symbol strings, typographical representations, in particular font colors, font weights or font sizes, or numbers. According to a further embodiment, the indicators may reflect the respective difference or express the respective difference as a percentage of the hit count of the new search query. According to a further embodiment, the indicators can be output in the seventh step outside the search mask or inside the search mask next to the associated search term. According to a further embodiment, one, more than one or all of the search terms can be composed of further search terms.

According to another embodiment, on a computer-readable data medium, a computer program is stored which performs the method as described above when it is executed in a computer.

According to yet another embodiment, a computer program can be executed in a computer and in the process performs the method as described above.

### BRIEF DESCRIPTION OF THE DRAWINGS

Exemplary embodiments are explained below with reference to figures, in which:

FIG. 1 shows a search mask containing a conventional search query,

FIG. 2 shows a program flowchart for the method,

FIG. 3 shows a search mask containing a search query and indicators which are output numerically,

FIG. 4 shows a search mask containing a search query and indicators which are output by means of symbols,

FIG. 5 shows a search mask containing a search query and indicators which are output as bars,

FIG. 6 shows a search mask containing a search query and indicators which are output as colored areas, and

FIG. 7 shows a search mask containing a search query and indicators which are output in the form of font sizes or font weights.

### DETAILED DESCRIPTION

According to various embodiments, a microprocessor is programmed to record in a first step with the aid of a search mask a search query consisting at least of a first search term and a second search term, the two search terms being linked by means of a first operator. Furthermore, the microprocessor is programmed to perform the following steps iteratively while the search mask is continuously displayed by a visual output means:

Firstly, changes to the previous search query are made in the search mask in a second step, in particular by modifying, removing or adding search terms, thereby forming a new search query. Next, a database query is submitted with the new search query in order to determine a hit count in a third step. Thereafter, a modified search query is formed for each search term of the new search query in a fourth step by removing the respective search term from the new search query. The database is thereupon interrogated with the respective modified search query in order to determine a modified hit count in a fifth step. In a sixth step a difference is calculated between the modified hit count and the hit count of the new search query. In a seventh step an indicator for the respective search term is determined on the basis of the calculated difference and output.

By means of the indicators the method enables an individual contribution to a search result made by the individual search terms of a search query consisting of a plurality of search terms linked by means of logical operators to be output to a user. If the user wished to determine the individual contribution in some other way, he/she would have to perform the search query manually without the respective search term and compare the number of returned hits with the number of hits for the original search query. This would have to be repeated for each search term. The effort involved in this would be disproportionately high for a relatively extensive search query.

By means of the method the user is provided with an optimization which indicates by means of an indicator the individual contribution of each search term used. For this purpose there is started in the background for each search term a search query consisting of the original search query without the respective search term. The hit count thus obtained is subtracted from the total hit count of the original search query including the relevant search term. The difference obtained in this process is a numerical indicator for the individual contribution of the respective search term to the hit count.

By virtue of the above-described analysis of the individual contributions of the search terms to the total hit count and the output of the associated indicators which furnish information about the individual contribution of the individual search terms, the user is spared the task of submitting separate search queries with the omission of one search term in each case and then comparing the returned hit count. The user quickly and conveniently obtains assistance in determining which search terms are crucial to his/her search query. He/she can thus selectively refine and optimize his/her search query, e.g. by explicitly specifying less significant search terms or removing overly restrictive search terms or by linking and extending them with alternatives via OR operators.

As well as the method just described other embodiments also include a computer-readable data medium on which a computer program is stored which performs the method just described when it is executed in a computer.

According to yet other embodiments, a computer program can be executed in a computer and in the process performs one of the above-described methods.

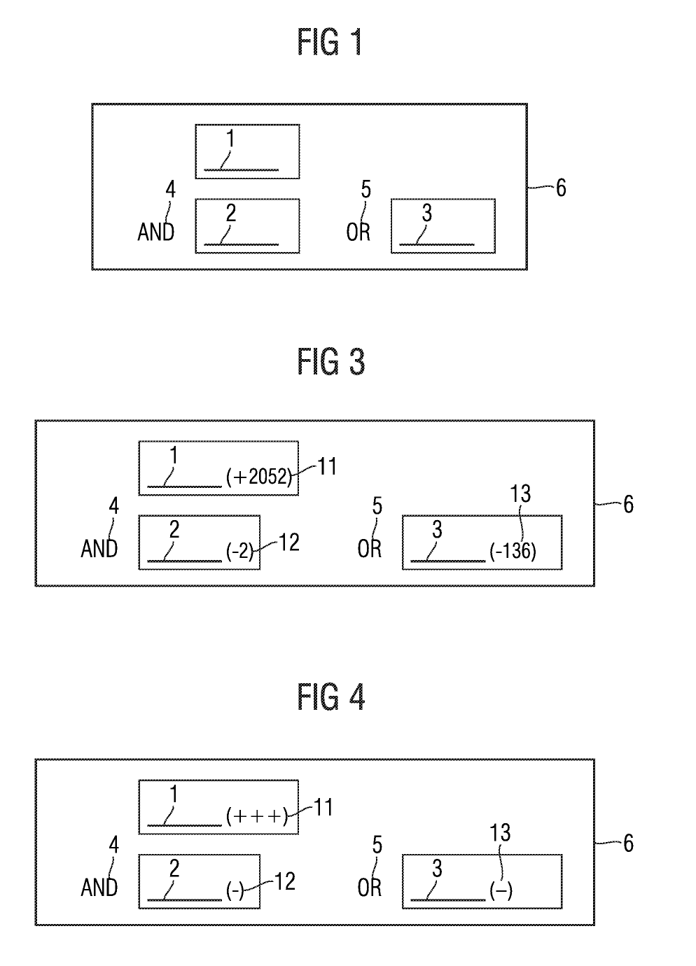

FIG. 1 shows a search mask containing a search query according to the prior art. A user enters a first search term 1, a second search term 2 and a third search term 3 in a search mask 6. The second search term 2 and the third search term 3 are contained in a separate line which acts mathematically like a bracket around the two search terms. The first line containing the first search term 1 is linked with the second line containing the second search term 2 and the third search term 3 via a first operator 4, in this case an AND operator (logical AND). The second search term 2 and the third search term 3 are linked via a second operator 5, in this case an OR operator (logical OR). In the prior art the individual hits returned after the search query has been submitted are classified manually if necessary in order to determine which search terms were responsible for the respective hit.

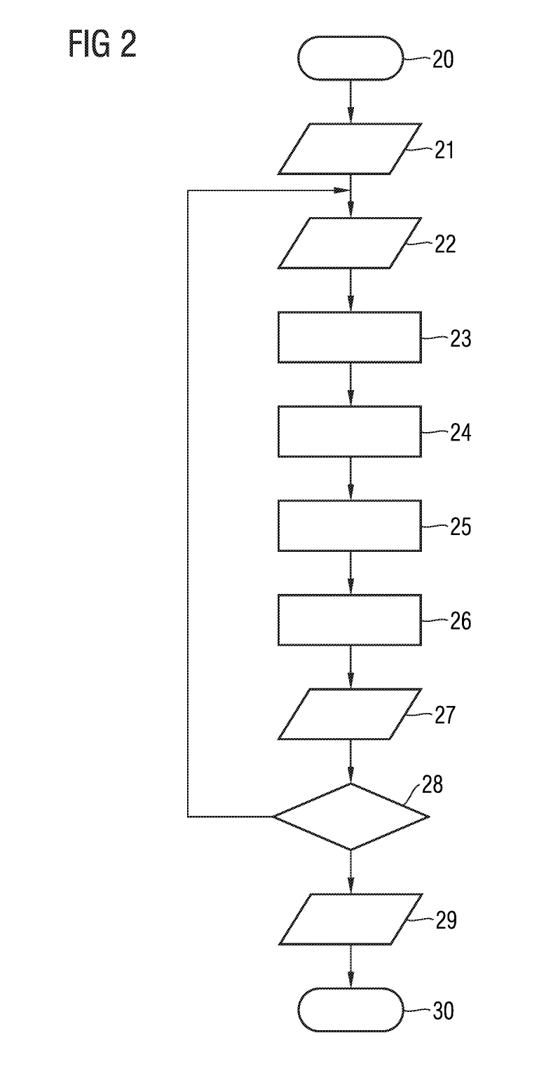

An exemplary embodiment is explained below with reference to the program flowchart in FIG. 2 in conjunction with the illustration in FIG. 3. After a start 20, search terms and operators for a search query are recorded in a first step 21 with the aid of a search mask 6. In this case FIG. 3 once again shows the elements already introduced in FIG. 1. Accordingly, the search query is a complex search term in the form:

### [First Search Term 1 and (Second Search Term 2 or Third Search Term 3)]

In order to optimize the search query, a second step 22, a third step 23, a fourth step 24, a fifth step 25, a sixth step 26, a seventh step 27 and an eighth step 28 are performed iteratively while the search mask 6 is continuously displayed by a visual output means. The visual output means can be for example a display screen or a video projector.

In the second step 22, changes to the previous search query in the search mask 6, in particular as a result of modifying, removing or adding search terms, are recorded, thereby forming a new search query. In FIG. 3 this change, brought about for example as a result of adding the third search term 3, has already been made. Now a database is interrogated with the new search query in order to determine a hit count in a third step 23. In the exemplary embodiment a hit count of 150 is determined in this case.

A selection of said hits (e.g. the first ten) is retrieved from the database and for example output below the search mask 6 via the visual output means.

A modified search query is now formed for the first search term 1 of the new search query in a fourth step 24 by removing the first search term 1 from the new search query:

### (Second Search Term 2 or Third Search Term 3)

Next, in a fifth step 25, the database is interrogated with the modified search query, a modified hit count, in this case 2202, being determined. The difference between the modified hit count (2202) and the hit count of the new search query (150) is thereupon calculated in a sixth step 26 as 2052. Finally, in a seventh step 27, a first indicator 11 for the first search term 1 is determined for the difference in the form of the character string “+2052” and, as shown in FIG. 3, output to the user in the search mask 6 in brackets after the first search term 1.

A modified search query is formed in the same way for the second search term 2 (fourth step 24) by removing the second search term 2 from the new search query:

### (First Search Term 1 and Third Search Term 3)

When the database is interrogated, this search query returns a modified hit count of 148. The difference between this modified hit count and the hit count of the new search query is −2. For this, a character string “−2” is formed as the second indicator 12 and output as shown in FIG. 3.

A modified search query is formed for the third search term 3 (fourth step 24) by removing the third search term 3 from the new search query:

### (First Search Term 1 and Second Search Term 2)

When the database is interrogated, this search query returns a modified hit count of 14. The difference between this modified hit count and the hit count of the new search query is −136. For this, a character string “−136” is formed as the third indicator 13 and output as shown in FIG. 3.

In the eighth step 28 a check is now made to determine whether an abort criterion has been met. The abort criterion is met for example when a user closes a window containing the search mask 6 by means of a corresponding input or terminates the processing of the search query. Otherwise the steps starting with the second step 22 are repeated if the user makes further changes to the search query.

As soon as the abort criterion has been met, a computer program which provides the search mask 6 is terminated in a ninth step 29. Alternatively a window containing the search mask 6 can be closed and instead a window opened which displays a hit quantity for the search query. If search mask 6 and hit quantity were already displayed together previously in a window, the search mask 6 can be hidden, thereby making more space available for outputting the hit quantity. This is followed by an end 30 in the program flowchart shown in FIG. 2.

In the exemplary embodiment shown in FIG. 3, the difference is formed by subtracting the hit count of the new search query from the modified hit count. The first indicator 11 should therefore be understood as meaning that 2052 additional hits would be returned if the first search term 1 were omitted. Alternatively the difference can also be formed by subtracting the modified hit count from the new search query. In this case the first indicator 11 would be “−2052” and would have to be understood in the sense that the first search term 1 limits the present new search query by 2052 hits. Alternatively the difference in the hit count of the new search query can also be calculated as a percentage instead of as an absolute difference and expressed as the first indicator 11. The percentage can also be calculated by summing the differences for all search terms and then calculating the respective difference as a percentage of the summed difference.

FIG. 4 shows the same elements as in FIG. 3. The first indicator 11, the second indicator 12 and the third indicator 13 are in this case embodied as symbol strings. Plus signs indicate here that the hit count would increase if the respective search term were omitted, whereas minus signs indicate that the hit count would decrease if the respective search term were omitted. The number of signs is proportional to the respective increase or the respective decrease.

Alternatively plus signs can indicate that the hit count would decrease if the respective search term were omitted, i.e. that the respective search term makes a positive contribution to the hit count. Minus signs then indicate that the respective search term reduces the hit count.

In the exemplary embodiment shown in FIG. 4 the indicators are varied in discrete steps (symbol sign by symbol sign). This representation has the advantage that it conveys a quick and clear differentiation between the different contributions of the search terms.

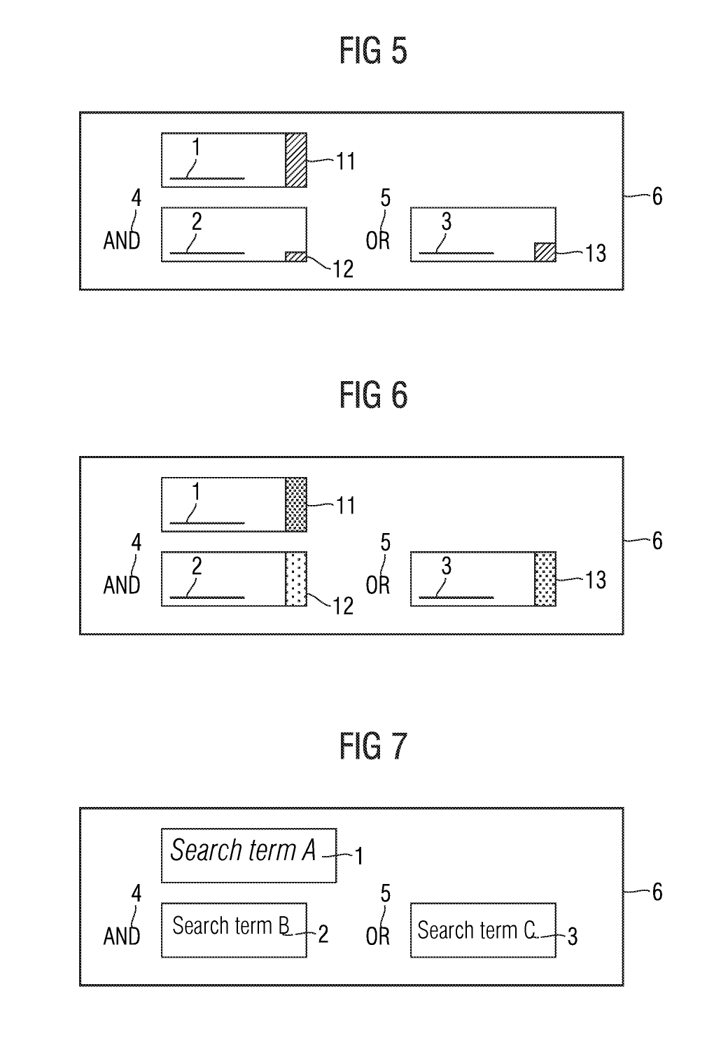

FIG. 5 shows the same elements as FIG. 4. The first indicator 11, the second indicator 12 and the third indicator 13 are in this case embodied as bars. The height of the bars is in this case proportional to the individual contribution of the respective search term and is calculated as a percentage as described above.

FIG. 6 shows the same elements as FIG. 5. The first indicator 11, the second indicator 12 and the third indicator 13 are in this case embodied as colored areas (indicated by hatching in FIG. 6). In this case the saturation level of the colored areas proportionally reflects the individual contribution of the respective search term and is likewise calculated as a percentage.

As an alternative to the already described numerical and graphical representations for the indicators, FIG. 7 shows an exemplary embodiment in which the indicators are represented typographically in that the font sizes of the search terms are altered in such a way that the size of the font reflects the individual contribution of the respective search term. Like reference signs in FIG. 7 in this case designate the same elements as in FIG. 6.

As shown in FIGS. 3-7, the indicators can be represented within the search mask 6 directly next to the respective search terms. Alternatively the indicators can also be output separately, e.g. in a separate table.

The search terms are terms (technical terms), regular expressions (character strings describing a set of character strings), any other character strings, etc. The search terms can also be compound terms. This means that the first search term 1 for example consists in turn of a grouping of search terms which are linked via logical operators or proximity operators. In this case the first indicator 11 determined for the first search term 1 is an indicator for the complete grouping of search terms of which the first search term 1 is composed.

NOR, XOR, NEAR, NOT etc. are also possible as suitable operators between the search terms in addition to AND and OR.

The variants and exemplary embodiments described can be freely combined with one another.

What is claimed is:

1. A method for optimizing a search query, wherein a microprocessor is programmed to
record in a first step with the aid of a search mask a search query which consists at least of a first search term and a second search term, the two search terms being linked by means of a first operator, and
perform the following steps iteratively while the search mask is continuously displayed by a visual output means:
recording changes to the previous search query in the search mask in a second step, in particular as a result of modifying, removing or adding search terms, thereby forming a new search query,
interrogating a database with the new search query in order to determine a hit count in a third step,
for each search term of the new search query forming a modified search query in a fourth step by removing the respective search term from the new search query,
interrogating the database with the respective modified search query in order to determine a modified hit count in a fifth step,
calculating a difference between the modified hit count and the hit count of the new search query in a sixth step, and
determining an indicator for the respective search term on the basis of the calculated difference and output the indicator in a seventh step.

2. The method according to claim 1, wherein the indicators are graphical representations.

3. The method according to claim 2, wherein the graphical representations bars, colored areas or symbol strings, typographical representations.

4. The method according to claim 2, wherein the graphical representations are font colors, font weights or font sizes, or numbers.

5. The method according to claim 1, wherein the indicators reflect the respective difference or express the respective difference as a percentage of the hit count of the new search query.

6. The method according to claim 1, wherein the indicators are output in the seventh step outside the search mask or inside the search mask next to the associated search term.

7. The method according to claim 1, wherein one, more than one or all of the search terms are composed of further search terms.

8. A computer-readable data medium storing instructions which when executed on a computer perform the steps of:
record in a first step with the aid of a search mask a search query which consists at least of a first search term and a second search term, the two search terms being linked by means of a first operator, and
perform iteratively while the search mask is continuously displayed by a visual output means the steps of:
recording changes to the previous search query in the search mask in a second step, in particular as a result of modifying, removing or adding search terms, thereby forming a new search query,
interrogating a database with the new search query in order to determine a hit count in a third step,
for each search term of the new search query forming a modified search query in a fourth step by removing the respective search term from the new search query,
interrogating the database with the respective modified search query in order to determine a modified hit count in a fifth step,
calculating a difference between the modified hit count and the hit count of the new search query in a sixth step, and
determining an indicator for the respective search term on the basis of the calculated difference and output the indicator in a seventh step.

9. The data medium according to claim 8, wherein the indicators are graphical representations comprising at least one of bars, colored areas or symbol strings, typographical representations, font colors, font weights, font sizes, and numbers.

10. The data medium according to claim 8, wherein the indicators reflect the respective difference or express the respective difference as a percentage of the hit count of the new search query.

11. The data medium according to claim 8, wherein the indicators are output in the seventh step outside the search mask or inside the search mask next to the associated search term.

12. The data medium according to claim 8, wherein one, more than one or all of the search terms are composed of further search terms.

13. A system comprising a computer which is programmed:
to record in a first step with the aid of a search mask a search query which consists at least of a first search term and a second search term, the two search terms being linked by means of a first operator, and
to perform iteratively while the search mask is continuously displayed by a visual output means the steps of:
recording changes to the previous search query in the search mask in a second step, in particular as a result of modifying, removing or adding search terms, thereby forming a new search query,
interrogating a database with the new search query in order to determine a hit count in a third step,
for each search term of the new search query forming a modified search query in a fourth step by removing the respective search term from the new search query,
interrogating the database with the respective modified search query in order to determine a modified hit count in a fifth step,
calculating a difference between the modified hit count and the hit count of the new search query in a sixth step, and
determining an indicator for the respective search term on the basis of the calculated difference and output the indicator in a seventh step.

14. The system according to claim 13, wherein the indicators are graphical representations.

15. The system according to claim 14, wherein the graphical representations bars, colored areas or symbol strings, typographical representations.

16. The system according to claim 14, wherein the graphical representations are font colors, font weights or font sizes, or numbers.

17. The system according to claim 13, wherein the indicators reflect the respective difference or express the respective difference as a percentage of the hit count of the new search query.

18. The system according to claim 13, wherein the indicators are output in the seventh step outside the search mask or inside the search mask next to the associated search term.

19. The system according to claim 13, wherein one, more than one or all of the search terms are composed of further search terms.
